(19) United States
(12) Patent Application Publication
(10) Pub. No.: US 2025/0315832 A1
(43) Pub. Date: Oct. 9, 2025

(54) Information-Security System and Method for Secure Transaction Validation and Authorizations at Transaction Processing Points

(71) Applicant: Bank of America Corporation, Charlotte, NC (US)

(72) Inventors: Saurabh Garg, Waxhaw, NC (US); Shailendra Singh, Maharashtra (IN); Maneesh Kumar Sethia, Hyderabad (IN); Preeti Yadav, Gurugram (IN)

(21) Appl. No.: 18/625,445

(22) Filed: Apr. 3, 2024

(51) Int. Cl. G06Q 20/40; G06F 3/0482; G06Q 10/087; G06Q 20/20; G06Q 20/32; G06Q 20/36; H04L 9/32

(52) U.S. Cl. CPC G06Q 20/40145; G06F 3/0482; G06Q 10/087; G06Q 20/209; G06Q 20/3276; G06Q 20/3278; G06Q 20/36; H04L 9/3247

(57) ABSTRACT

Systems and methods enable customers to participate in transaction verification. A DH for network selection and management, ensures continuous and secure processing of transactions through dynamic network switching. A COPP establishes a fail-safe connection with alternate acquirers, providing flexibility and reliability in transaction processing. A RPDS is used to hold the transaction amount in reserve, releasing funds only upon customer validation of the transaction details received via a real-time notification on their mobile device. This process leverages the NDC standard for the exchange of transaction data across the network, enhancing communication between the POS terminal, the payment acquirer, and the issuing bank. The system provides a seamless, secure transaction experience for customers by giving them control over the approval of their purchases, thus reducing errors, enhancing trust, and streamlining the checkout process. It also offers merchants a strong, fraud-resistant transaction mechanism that integrates seamlessly with existing POS technology.

### TECHNICAL FIELD

The present disclosure relates to information security and, in particular, to authentication, access control, and authorization in the context of enhancing security measures in the realm of electronic transactions, particularly focusing on the secure orchestration of transaction processing points within retail environments. This innovative system leverages sophisticated digital communication technologies and advanced security protocols to ensure the integrity and privacy of transaction data from the moment of item selection to the final payment approval by customers. By integrating features such as real-time transaction validation, secure data exchange, and dynamic payment authorization, the invention aims to significantly reduce the incidence of fraud, unauthorized charges, and data breaches, thereby elevating the overall security and trustworthiness of retail transactions.

### DESCRIPTION OF THE RELATED ART

In the traditional retail environment, a significant problem exists at the point of sale (POS) that affects customer confidence and satisfaction: the lack of transparency and real-time visibility into the transaction process. As customers make their purchases, they entrust the merchant with the accuracy of item scanning and billing at the POS terminal. This leap of faith, however, opens up room for discrepancies that can lead to frustration, distrust, and potential disputes.

When a customer proceeds to checkout, the merchant scans each item to tally up the total cost. During this critical phase of the shopping experience, the customer has no direct way to verify what items are being scanned, the quantity of each item, or the price being applied. The transaction process is essentially a black box to the customer until the completion of payment, at which point they receive a printed receipt detailing their purchase. This delayed feedback mechanism does not allow for real-time oversight or intervention by the customer, should there be any errors or misunderstandings about what should be included in the bill. This is especially problematic due to the fast pace of the checkout, such as in grocery stores, and impatient customers potentially waiting in line to checkout.

Errors at the POS can range from simple mistakes, such as scanning an item twice, to more complex issues like incorrect pricing or applying the wrong discounts. While often unintentional, these errors can lead to overcharging, undercharging, or simply billing for items that were not part of the customer's actual selection. Resolving these errors post-transaction not only requires additional time and effort from both the customer and the merchant but can also lead to feelings of embarrassment or conflict at the point of sale, affecting the overall shopping experience.

Moreover, in situations where discrepancies are discovered after the customer has left the merchant's premises, the process of seeking redress becomes even more cumbersome. The customer may need to return to the store with the items and the receipt, engage in discussions or disputes with the store staff, and undergo a manual process to rectify the billing error. This inconvenience is compounded by the fact that the burden of proof often lies with the customer to demonstrate that an error was made, which can sometimes be challenging or impractical.

This fundamental problem within the retail checkout process undermines consumer confidence and can detract from the overall shopping experience. It highlights a need for greater transparency, real-time validation, and control in retail transactions to ensure that customers have direct oversight over the accuracy of their transactions, enhancing trust and satisfaction in the retail experience.

### SUMMARY OF THE INVENTION

The invention presented tackles the aforementioned issues at the point of sale with a groundbreaking approach that revolutionizes the way transactions are conducted, ensuring transparency, security, and customer control. The disclosed systems and methods introduce a seamless integration of technology at the POS to empower customers and streamline the payment process.

The invention utilizes a Device Handler (DH) and a Control Object Payment Processor (COPP), coupled with the introduction of a Reserved Payment Driven Switch (RPDS). These components work in concert to transform the transaction process, allowing for real-time interaction and approval of transactions by the customer, thus addressing the core issues of transparency and trust at the POS.

The Device Handler plays a pivotal role in this system, acting as a dynamic switch that facilitates the seamless transition between different payment networks. This ensures that transactions can proceed without interruption, even in the event of issues with the primary payment acquirer. It is a component that enhances the reliability and fluidity of the transaction process.

The COPP is another cornerstone of the invention, providing a secure communication channel between the merchant's POS system and the customer's payment method. It ensures compatibility and secure data transmission across diverse payment platforms, effectively mitigating risks associated with payment failures or security breaches. This component not only enhances the security of transactions but also significantly improves the customer's experience by ensuring that their payment is processed smoothly and securely.

A significant innovation introduced by this system is the RPDS, which holds payments in a reserved state until the customer has had the chance to review and approve the charges on their mobile device. This offers customers unprecedented control over their transactions. They can verify the items and prices charged in real-time, approving the payment only once they are satisfied with the accuracy of the transaction. This process eliminates the possibility of billing errors and unauthorized charges, significantly enhancing customer trust and satisfaction.

Moreover, the system leverages New Distribution Capability (NDC) to orchestrate data exchange across the transaction processing network. NDC allows for efficient and secure communication of transaction data, ensuring that all parties involved have access to accurate and timely information. This capability is essential for the real-time validation process enabled by the invention, as it ensures that data exchange between the customer, merchant, and payment processors is seamless and error-free.

In essence, the invention presents a holistic solution to the problems plaguing traditional POS transactions. By integrating advanced technological components and innovative processing methods, it offers a secure, transparent, and customer-centric transaction process. Customers gain unprecedented control over their purchases, with the ability to review and approve every item before payment is finalized, thereby significantly reducing the potential for errors, and enhancing the overall shopping experience.

This system not only benefits customers by providing them with peace of mind and a sense of empowerment but also aids merchants by reducing disputes, enhancing the efficiency of the checkout process, and improving customer satisfaction and loyalty. It represents a significant step forward in the evolution of retail transactions, setting a new standard for transparency, security, and customer engagement in the shopping experience.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

Various core features address longstanding challenges in the point of sale (POS) transactions. These features collectively enhance transparency, security, and customer control over the transaction process, fundamentally transforming the retail checkout experience. Each feature plays a specific role in achieving this transformation, contributing to a more reliable, customer-friendly payment ecosystem.

A cornerstone of this invention, the Device Handler (DH), acts as a dynamic intermediary that facilitates seamless communication between various components of the payment process. By managing the switch between different payment networks, the DH ensures that transactions are not hindered by technical glitches or compatibility issues with the primary payment acquirer. This feature significantly reduces transaction failures, contributing to a smoother checkout experience for customers and reducing operational friction for merchants.

The Control Object Payment Processor (COPP) is instrumental in establishing a secure and compatible connection between the merchant's POS system and the customer's payment method. It integrates various components that assist in dynamically adapting to new acquirers and transforming data to ensure compatibility and security. This adaptability is crucial in a diverse retail environment where different payment systems and standards coexist. The COPP thus plays a vital role in safeguarding transaction integrity and enhancing customer trust.

The Reserved Payment Driven Switch (RPDS) is a novel approach to managing payment authorization, whereby the RPDS holds the payment for items in a reserved state until the customer approves the transaction. This mechanism empowers customers, giving them direct control over their purchases and the final payment authorization. It addresses the core issue of transactional transparency, allowing customers to review and validate their purchases in real-time before committing their funds.

Leveraging New Distribution Capability (NDC) for data orchestration is another innovative aspect of this invention. NDC facilitates efficient and secure data exchange across the distributed transaction processing network, ensuring that all parties involved have access to accurate and timely transaction data. This feature is essential for the real-time validation and approval process enabled by the system, as it underpins the seamless and error-free communication between customers, merchants, and payment processors.

The invention includes the capability for real-time transaction validation. Customers receive notifications on their mobile devices detailing the items and costs involved in the transaction, which they can review and approve before the payment is processed. This immediate feedback loop ensures that any discrepancies can be addressed on the spot, significantly reducing the likelihood of post-transaction disputes, and enhancing customer satisfaction.

The system incorporates enhanced security measures and advanced security protocols to protect transaction data and prevent unauthorized access. By ensuring the secure transmission of data between the POS device, the customer's mobile device, and the payment processing network, the invention mitigates risks associated with data breaches, fraud, and payment errors. These security measures are crucial for maintaining customer trust and compliance with regulatory standards.

A key feature of this invention is its compatibility with a wide range of payment networks. This flexibility ensures that merchants can cater to customers with diverse payment preferences, from traditional credit and debit cards to newer digital wallets and mobile payment solutions. The system's ability to interface seamlessly with different payment technologies makes it highly adaptable to various retail settings.

The dynamic device handling capability of the DH allows for real-time adjustments to the payment process based on the transaction's specific needs and conditions. This feature ensures optimal routing of payment requests, enhancing the efficiency and reliability of the payment process. It represents a significant advancement over static payment systems, which can be prone to failures and inefficiencies.

The invention features a user-friendly interface on the customer's mobile device, which displays the transaction details clearly and allows for easy review and approval of purchases. This interface is designed with the customer's experience in mind, ensuring that the validation and approval process is intuitive and straightforward. By prioritizing usability, the system enhances customer engagement and satisfaction with the payment process.

Another innovative feature is the system's ability to handle post-transaction adjustments. Customers can initiate returns or dispute charges through the same interface used for transaction validation, leveraging the RPDS to adjust the payment reservation and processing accordingly. This capability extends the system's utility beyond the point of sale, offering customers continued control over their transactions and simplifying the returns and refunds process.

Collectively, these features represent a comprehensive overhaul of the traditional POS transaction process, addressing critical pain points for both customers and merchants. By enhancing transparency, security, and control, the invention sets a new standard for retail transactions, promising a future where checkout processes are more aligned with the needs and expectations of the modern consumer.

In some arrangements, the invention is an advanced system engineered to enhance the payment process at merchant Point of Sale (POS) desks, providing a customer-centric and streamlined transaction experience. When a customer begins a transaction by scanning a merchant's POS identifier, this triggers the system, signaling the POS to initiate the transaction process. The POS system then intelligently processes and appends necessary details, such as items, prices, and quantities, to a formatted request. This is routed through the merchant's network to the payment acquirer, the financial entity responsible for processing card payments.

After the acquirer receives the transaction details, it attempts to establish a secure connection with the customer's issuing bank, which has provided the customer's payment card. Upon successful contact, the bank sends a notification to the customer's mobile device, often through a banking app, providing an itemized list of the transaction for the customer's review in real-time. This real-time notification allows customers to be fully aware and in control of their transactions, enhancing trust and satisfaction with the payment process.

Central to this system's reliability and efficiency is the Device Handler (DH), which determines the optimal payment network for the transaction. If there are any issues with the primary payment network, the DH is responsible for switching to an alternative to ensure the transaction can continue smoothly. The system's flexibility is further strengthened by the Control Object Payment Processor (COPP). If the primary acquirer fails, the COPP adapts the transaction data into a compatible mode for a new acquirer, ensuring the transaction is processed without interruptions.

Moreover, the invention integrates the Reserved Payment Driven Switch (RPDS), a specialized switch that reserves the total payment amount for the items in the cart. This reservation remains until the customer approves the transaction, thus providing an additional layer of financial security and control.

Data orchestration within the system is handled by the New Distribution Capability (NDC), which repurposes a travel industry-supported communication enhancement program to suit the needs of retail transactions. NDC formats the transaction data effectively, allowing for a secure and efficient transfer of information across the payment processing network. This ensures that the data exchange from the POS system to the acquirer and the issuing bank is seamless and secure.

In essence, this invention addresses both the visible aspects of the customer interaction and the intricate back-end processing that occurs during a transaction. By ensuring a secure, transparent, and efficient process, it provides benefits for customers, merchants, and financial institutions alike. Customers gain more control and insight into their purchases, merchants experience smoother operations and fewer disputes, and banks enjoy the enhanced security and efficiency of the payment processing. This system stands as a testament to the potential for technology to create a more seamless, secure, and customer-friendly retail environment.

In some embodiments, a method is provided for secure transaction processing at a point of sale (POS) device with the use of a mobile device. This method includes several steps to ensure security and efficiency. It begins when a user initiates the transaction by scanning a merchant's POS identifier using their mobile device. To establish a secure communication link between the mobile device and the POS device, the user may scan a QR code or engage NFC (Near Field Communication). Once established, transaction data is transmitted from the POS device to the mobile device, which includes a detailed list of items along with their respective prices.

Upon receiving this information, the mobile device displays the transaction data, enabling the user to validate or modify the list of items. This step allows the user to confirm the accuracy of the transaction details. Following the user's validation, the transaction data, as confirmed by the user, is encoded into a New Distribution Capability (NDC) packet. This packet is optimized for secure and efficient data exchange across distributed systems, which is then transmitted to a Control Object Payment Processor (COPP). The COPP has a specific configuration that allows it to interface with both the mobile device and the POS device, thereby facilitating the authentication of the transaction data and ensuring it complies with established financial transaction standards.

The COPP, in conjunction with a Reserved Payment Drive Switch (RPDS), reserves the transaction amount in the user's account. This reservation is done without finalizing the transaction, which secures the funds for the transaction while still permitting any necessary adjustments before the transaction is completed. A Device Handler (DH) operates within the transaction processing system to dynamically manage the data flow and transaction logic among the POS device, the mobile device, the COPP, and financial institutions. This management is critical to ensure the transaction adheres to predefined security and processing rules.

The method concludes with the COPP instructing the financial institution to transfer the reserved amount from the user's account to the merchant's account. This instruction is sent after receiving final confirmation from the user via their mobile device. Subsequently, a secure electronic receipt is generated and transmitted to both the user's mobile device and the merchant's POS system, serving as a record of the transaction for both parties involved. Furthermore, the method allows for post-transaction adjustments by the user through their mobile device. For example, users may initiate returns or disputes, and the system will dynamically update the transaction records and adjust the financial accounts as needed. This dynamic updating is facilitated by the RPDS, COPP, and DH components, which ensure a seamless and secure process for modifying and settling transactions.

In some embodiments, an additional step incorporates a biometric authentication procedure on the mobile device. Users are required to authenticate their identity via fingerprint scanning, facial recognition, or voice verification before the transaction data is allowed to be transmitted to the Control Object Payment Processor (COPP) for further processing. This biometric step ensures that the initiation of the transaction is protected, and the identity of the user is securely verified.

In some embodiments, the communication link between the mobile device and the POS device is secured using an advanced encryption standard (AES) with a minimum key length of 256 bits. This encryption guards the transaction data against any potential interception or unauthorized access as it moves from the mobile device to the POS device, maintaining the integrity and confidentiality of the user's sensitive information throughout the transaction process.

In some embodiments, the COPP is designed to dynamically select the most efficient transaction processing route. This selection is based on the specific type of transaction, the amount involved, and the current load on the network. The Reserved Payment Drive Switch (RPDS) plays a critical role in this step by dynamically allocating resources for transaction processing, optimizing both the time and efficiency of the transaction's journey through the system.

In some embodiments, once the user has validated the transaction on their mobile device, the COPP generates a unique transaction identifier (UTI). This identifier is embedded within the New Distribution Capability (NDC) packet and is utilized by the Device Handler (DH) to meticulously track and manage the transaction throughout its various processing stages. The UTI becomes an essential tool for creating audit trails and verifying transactions, adding an additional layer of security and traceability to the process.

In some embodiments, the system is configured to send out notifications to both the user's mobile device and the merchant's POS device once a transaction is successfully completed. These notifications include the UTI and a concise summary of the transaction details. Additionally, the transaction status is updated in real-time on a platform accessible by the user, boosting transparency and providing immediate confirmation of the transaction status to all parties involved. This immediate feedback loop ensures that both the user and the merchant are kept informed of the transaction's outcome as soon as it is finalized.

In some embodiments, to enhance the transaction process, the system includes a method where the transaction is initiated by scanning a QR code displayed on the Point of Sale (POS) device using the mobile device. This action establishes a communication link between the two devices. For the security of this link, a choice of secure wireless protocols is available, including Bluetooth, Wi-Fi, and NFC (Near Field Communication). Once the connection is established, the transaction data transmitted between the POS device, and the mobile device is protected by an end-to-end encryption protocol to prevent data breaches and ensure the confidentiality of the transaction.

The user interface on the mobile device allows for the selection and deselection of items, providing the flexibility to modify the total transaction amount as desired by the user. In addition to this flexibility, the method accommodates the application of user-specific discounts or loyalty points, which are applied to the transaction based on the validated transaction data before the transaction is finalized. This ensures that all eligible savings are accounted for in the transaction.

Upon completion of the transaction, a secure electronic receipt is generated. This receipt not only serves as proof of purchase but also features a digital signature from the merchant along with a timestamp, further enhancing the security and verifiability of the transaction. For user convenience, the secure electronic receipt can be stored in a digital wallet application on the user's mobile device.

In cases where a post-purchase modification is necessary, such as a return, the system provides an option within the digital wallet application to initiate this process. The user can deselect the returned items directly on the digital receipt, triggering a return process. This process includes notifying the merchant's POS device to ensure the merchant's inventory system is updated in accordance with the return.

Following the modification of a transaction, such as after a return, the system generates a new secure electronic receipt. This updated receipt reflects the modified transaction, including an updated total transaction amount and clear indications of the returned items, thereby maintaining a precise and up-to-date record of the transaction history.

The following description and the appended claims, with reference to the accompanying drawings, which all form a part of this specification and where like reference numerals designate corresponding parts in the various FIG.s, will make these and other features and characteristics of the current technology, as well as the methods of operation and functions of the related elements of structure and the combination of parts and economies of manufacture, more apparent. As computer-executable instructions (or as computer modules or in other computer constructs) recorded on computer-readable media, one or more of the different procedures or processes described herein may be implemented in whole or in part. Steps and functionality might be carried out on a single machine or dispersed over several devices that are connected to one another. However, it is clearly recognized that the drawings are meant primarily for descriptive and illustrative purposes and are not meant to define the boundaries of the invention. Unless the context makes it obvious otherwise, the single forms of “a,” “an,” and “the” as they appear in the specification and claims include plural referents.

### BRIEF DESCRIPTION OF DRAWINGS

FIGS. 1 and 2 collectively outline a technical flow diagram for an exemplary, innovative, POS transaction system. They detail the process from the initiation of a transaction by scanning the merchant's POS ID, through data processing and secure payment authorization, to the final approval of the transaction by the customer, leveraging advanced components like the Control Object Payment Processor (COPP) and the Reserved Payment Driven Switch (RPDS).

FIG. 3 displays the interface of a customer's mobile device, showing an itemized list of purchases with prices for validation during a POS transaction. It highlights the seamless interaction between the customer's device and the POS system, enabling real-time approval of transactions to enhance security and trust.

FIG. 4 illustrates the user interface on a customer's mobile device, offering options to either approve or dispute each item listed with their corresponding prices during a POS transaction. This interface empowers customers to actively participate in the transaction validation process, ensuring accuracy and transparency by allowing them to confirm or challenge the details of their purchase before final submission.

FIGS. 5 and 6 are flow diagrams showing sample interactions, interfaces, steps, functions, and components in accordance with one or more information security aspects of this disclosure with respect to exemplary, innovative, POS transaction systems.

### DETAILED DESCRIPTION

The following account of various example embodiments is designed to fulfill the objectives mentioned earlier, with reference to the accompanying illustrations that are relevant to this disclosure. These illustrations demonstrate multiple systems and methods for implementing the disclosed information. It is important to acknowledge that there are alternative implementations possible, and adjustments to both structure and functionality can be applied. The description outlines various links between elements, which are to be interpreted broadly. Unless specified otherwise, these connections can be either direct or indirect, and may be established through wired or wireless means. This document does not intend to limit the nature of these connections.

Terms like “computers,” “machines,” and similar phrases are interchangeably used herein, depending on the context, to refer to devices that can be general-purpose or specialized, designed for particular functions, either virtual or physical, or capable of connecting to networks. This includes all relevant hardware, software, and components familiar to those with expertise in the area. Such devices may be outfitted with specialized circuits like application-specific integrated circuits (ASICs), microprocessors, cores, or other processing units to execute, access, control, or implement various types of software, instructions, data, modules, processes, or routines as mentioned. The usage of these terms in the text is not intended to be limiting or exclusive to any specific kinds of electronic devices or components and should be interpreted in the widest sense by those with relevant expertise. Specific details on computer/software components, machines, etc., are not provided for the sake of brevity and under the assumption that such information is within the realm of understanding of skilled professionals in the domain.

Software, executable code, data, modules, procedures, and similar components can be housed on tangible, computer-readable physical storage devices. This encompasses everything from local memory and network-attached storage to diverse forms of memory that are accessible, whether they are removable, remote, cloud-based, or available via other channels. These components can be saved on both volatile and non-volatile memory and might operate under various conditions, including autonomously, upon request, according to a predetermined schedule, spontaneously, proactively, or in response to specific triggers. They can be stored together or distributed among several computers or devices, incorporating their memory and other parts. Moreover, these components can be housed or disseminated across network-accessible storage systems, within distributed databases, big data frameworks, blockchains, or distributed ledger technologies, either collectively or through distributed arrangements.

The phrase “networks” or similar terms refer to a broad range of communication systems, such as local area networks (LANs), wide area networks (WANs), the Internet, cloud-based networks, and both wired and wireless networks. This category also includes specialized networks like digital subscriber line (DSL) networks, frame relay networks, asynchronous transfer mode (ATM) networks, and virtual private networks (VPN), which may be interconnected in various ways. Networks are designed with specific interfaces to support different types of communications—internal, external, and managerial—with the capability to allocate virtual IP addresses (VIPs) to these interfaces as necessary. The architecture of a network is built upon an array of hardware and software elements. This includes, but is not limited to, access points, network adapters, buses, both wired and wireless ethernet adapters, firewalls, hubs, modems, routers, and switches, which may be positioned within the network, on its periphery, or outside. Software and executable instructions work on these components to enable network operations. Additionally, networks support HTTPS and a variety of other communication protocols, making them suitable for packet-based data transmission and communication.

As used herein, Generative Artificial Intelligence (AI) or the like refers to AI techniques that learn from a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative Al and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) Al Models-Meta LLAMA (Language Model Meta Al): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in the field of biology and medicine. (5) NVIDIA AI Models-Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in the field of generative Al. One or more of the foregoing may be used herein as desired. All are considered to be within the sphere and scope of this disclosure.

Generative AI and LLMs can be used in various aspects of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and utilizing large quantities of information effectively. (9) Data Classification: Categorizing and classifying data for better organization and analysis. (10) Feedback Learning: Processes whereby Al/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

At a high level, this disclosure details an innovative approach designed to revolutionize the way transactions are conducted at Point of Sale (POS) devices, focusing on enhancing security and transparency through the integration of Device Handler (DH) and Reserved Payment Driven Switch (RPDS) technologies. This advanced system addresses significant issues in retail transactions, primarily the inability of customers to verify the accuracy of their purchases in real-time and the vulnerability of current POS systems to security threats like data breaches and card skimming.

In traditional retail settings, customers face the challenge of not being able to confirm the items scanned by the merchant until after the payment is completed, often leading to discrepancies that are discovered only upon reviewing the receipt. This system aims to eliminate such discrepancies by enabling customers to participate directly in the validation of their transactions. Customers can view and approve the details of their purchases on their mobile devices before the payment is finalized, thereby ensuring that the transaction is accurate and to their satisfaction.

Another critical issue this system addresses is the risk associated with POS transactions, including potential security breaches that can occur when sensitive card information is intercepted by malicious devices. To combat this, the proposed invention incorporates secure electronic receipt transmission and robust encryption methods to safeguard customer data throughout the transaction process. This proactive approach to security significantly reduces the risk of fraud and unauthorized data access, providing customers with peace of mind when making purchases.

The system's architecture is built around several key components that work in harmony to process transactions securely and efficiently. The journey begins when the customer initiates the transaction by scanning a unique identifier on the merchant's POS device or a similar trigger is utilized. This action sets off a sequence of operations where the POS system collates essential information about the purchase and communicates with the relevant financial institutions involved in the transaction.

Central to the system's functionality is the Control Object for Payment Processor (COPP), which facilitates the secure transfer of transaction data between the POS system and the payment networks. The COPP ensures that data is formatted correctly and establishes reliable connections, even in scenarios where the primary payment network might be unavailable.

Collaboratively, the BASE24 switch and the Device Handler oversee the routing and processing of transaction data, selecting the most appropriate payment network based on real-time conditions to prevent transaction failures. This dynamic selection process is vital for maintaining transaction continuity and security.

For reference, BASE24 is a series of software applications produced by ACI Worldwide Inc. that facilitate payment processing and card transactions by financial institutions. The term “BASE24 switch” refers to the central transaction processing software that acts as the switch or hub in electronic funds transfer (EFT) systems. The BASE24 switch is responsible for routing transactions from ATMs, POS terminals, and bank branches to the cardholder's bank or card issuer for authorization. It supports various types of financial transactions, including credit and debit card transactions, ATM withdrawals, and point-of-sale (POS) purchases. BASE24 is known for its robustness and reliability in handling high volumes of transactions in real time, which is critical for banking systems that operate 24/7. It ensures that all transactions are processed efficiently and securely, providing services such as fraud detection, settlement, dispute management, and report generation. BASE24 systems have been widely used globally, especially in environments where high availability and high volume transaction processing are required. They have the capability to interface with various network protocols and can handle multiple transaction types, making them a key component in the financial transaction processing industry.

The introduction of the Reserved Payment Driven Switch (RPDS) enables holding the transaction amount in reserve until the customer validates the purchase through their mobile device. This innovative feature, powered by New Distribution Capability (NDC) standards, allows for efficient and secure data exchange, ensuring that all parties have access to accurate transaction information.

By enabling customers to approve or dispute each item on their mobile device, the system not only enhances transparency but also empowers them, putting control of the transaction in their hands. This level of direct involvement is unprecedented in traditional retail settings and marks a significant shift towards a more interactive and customer-centric shopping experience.

Furthermore, the system is designed with flexibility in mind, accommodating post-purchase adjustments through the same user interface. Customers can easily initiate returns or disputes, streamlining the process and improving overall satisfaction.

This comprehensive solution significantly advances retail transaction technology by addressing the critical needs for security, transparency, and customer control. By reducing errors, building trust, and facilitating smoother checkout processes, the invention benefits both consumers and merchants, offering a robust, fraud-resistant transaction mechanism that seamlessly integrates with existing POS systems.

In summary, the invention presents a holistic approach to redefining retail transactions, ensuring that they are secure, transparent, and aligned with the modern consumer's expectations. It represents a forward-thinking solution that protects both consumers and merchants, paving the way for a new standard in retail technology.

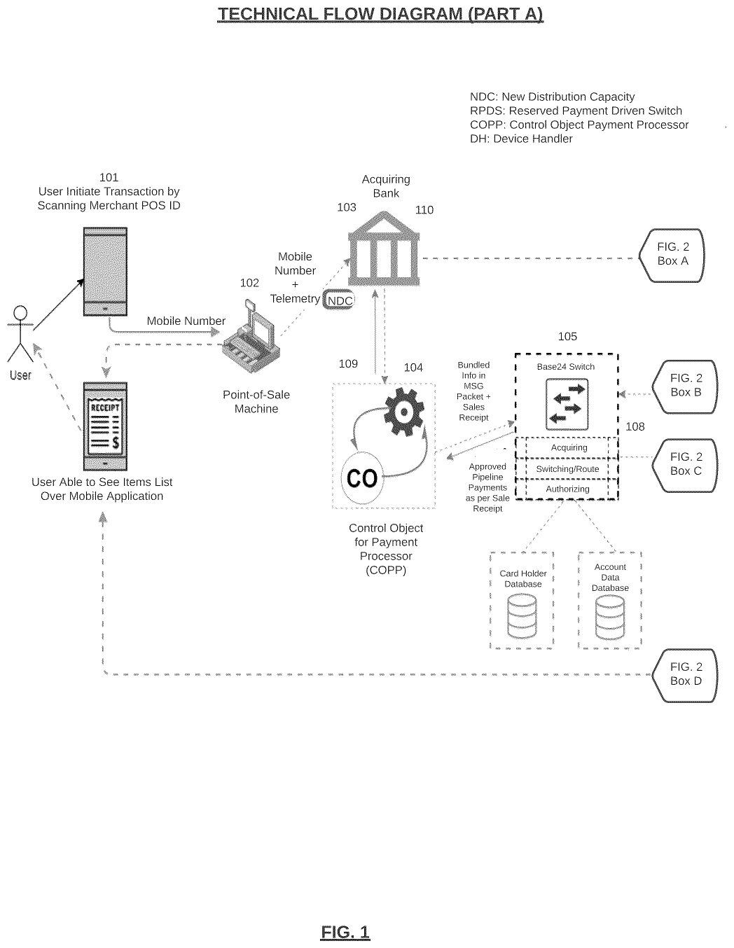

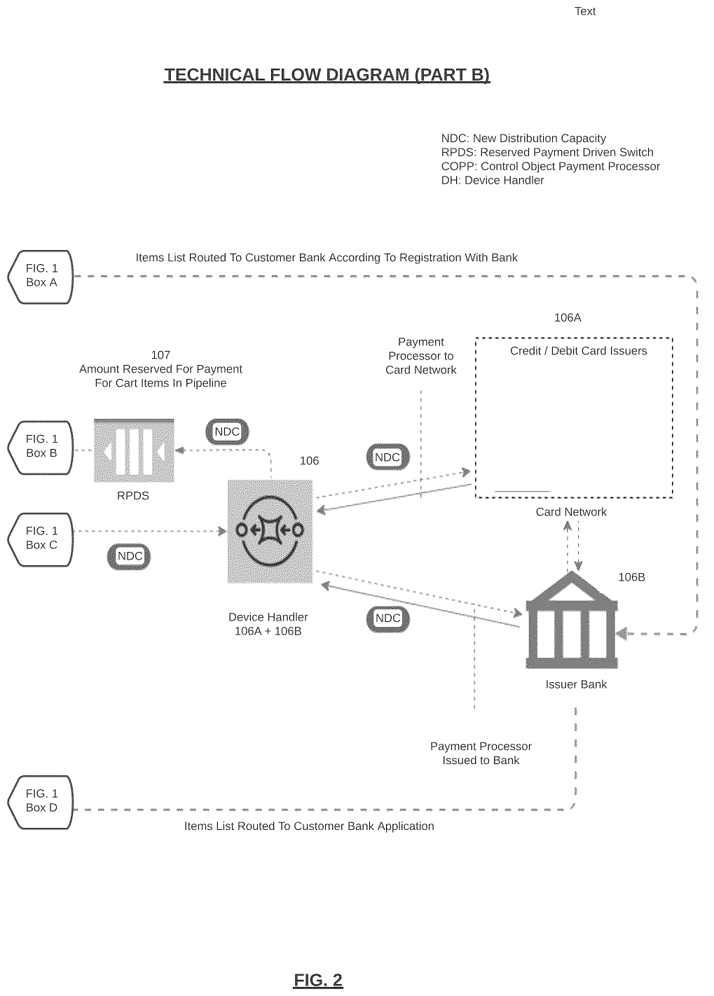

More specifically, and by way of non-limiting disclosure, the technical flow diagram, broken down into FIGS. 1 and 2, elaborates on a complex transactional system used at POS terminals and provides a comprehensive overview of the process flow. This system utilizes a series of sophisticated technological interactions to facilitate secure and transparent financial transactions for users at merchant locations.

FIG. 1 initiates the process with the user scanning the merchant POS ID (101). This scanning is the primary trigger for the subsequent data exchange and processing steps. It allows the POS machine (102) to gather the user's mobile number and related telemetry data. This information is crucial as it identifies the user's device and potentially their location, which is essential for secure transaction processing and fraud prevention. Other automated triggers may be used in addition or in lieu of scanning, such as, for example, near-field communication, a local Wi-Fi detection, Bluetooth, other proximity detection, or the like.

For reference, telemetry data for cellular phones and point of sale (POS) terminals refers to the automated communication processes by which measurements and other data are collected at remote or inaccessible points and transmitted to receiving equipment for monitoring, diagnosis, and operational control.

For cellular phones, telemetry data can include, inter alia:
a. Device Information: Model, operating system, hardware version, unique device identifiers.
b. Location Data: GPS coordinates, cell tower IDs, Wi-Fi hotspot locations.
c. Usage Statistics: Call logs, app usage times, data usage statistics.
d. Performance Metrics: Battery levels, signal strength, memory usage, CPU load.
e. Sensor Readings: Data from accelerometers, gyroscopes, magnetometers, and other onboard sensors.

For PoS terminals, telemetry data may encompass, inter alia:
a. Transaction Data: Information on transaction amounts, times, and frequencies.
b. Device Status: Power status, printer status, network connectivity.
c. Operational Metrics: Error logs, device uptime, and operational status.
d. Maintenance Information: Firmware versions, update history, maintenance alerts.
e. Security Posture: Security logins, access attempts, encryption status.

The acquired information then flows (103) to the acquiring bank, which plays a pivotal role in processing the transaction. The bank receives a package of data, including the initial user information, and initiates (104) the COPP (Control Object for Payment Processor, 109). The COPP is a sophisticated component designed to manage and facilitate secure communication between the POS machine and the acquiring bank's network. It ensures that the transaction details are correctly bundled and formatted for the subsequent steps.

At the center of this flow is the BASE24 switch (105), an advanced system that bridges the POS and the banking networks. It processes the transaction information against the cardholder and account databases, ensuring that the financial credentials are valid and that the transaction can be securely authorized.

The BASE24 switch receives bundled information in message packets plus the sales receipt from the COPP, and performs functions such as acquiring, switching/routing, and authorizing. Authorization is performed, in part, by accessing a card holder database and an account data database. The BASE24 switch returns to the COPP approved pipeline payments as per the sales receipt, which are then relayed back to the acquiring bank.

This process culminates in the generation of a sales receipt. The sales receipt is then directed through an approved switching/routing pipeline, responsible for managing payment authorizations based on the details of the sales receipt. This is where the transaction is validated and confirmed, ready for the final payment processing.

Off-diagram connections couple FIG. 1 with FIG. 2 and indicate data flow can be seen for FIG. 1/2 Box A, Box B, Box C, and Box D designation.

In FIG. 2, the RPDS (Reserved Payment Driven Switch, 107) enters the process, adding a layer of financial control and security. The RPDS temporarily holds the total payment amount for the items the user intends to purchase, effectively reserving the funds until the transaction is fully verified by the user. This ensures that funds are only transferred once the user has confirmed the transaction's accuracy, thus protecting both the user and the merchant from potential discrepancies or fraudulent activities.

The transaction data, including the items list, is then sent to the customer's bank. This transfer is facilitated by the NDC (New Distribution Capacity), which ensures that the data packet is efficiently and securely routed to the appropriate financial institution for transaction approval.

A key component that coordinates this part of the process is the device handler (DH), which intelligently manages the connection between the payment processor to the card network (106A) and the issuer bank (106B). The DH ensures that the reserved payment is correctly processed, authorized, and ultimately transferred in accordance with the validated sales receipt.

The culmination of these steps represents a sophisticated integration of transaction processing systems, from user initiation at the merchant POS to the secure handling of payment by financial institutions. The system's technical flow is meticulously designed to ensure that each step contributes to a secure, accurate, and user-verified transaction, reflecting the system's emphasis on security, user control, and transactional transparency.

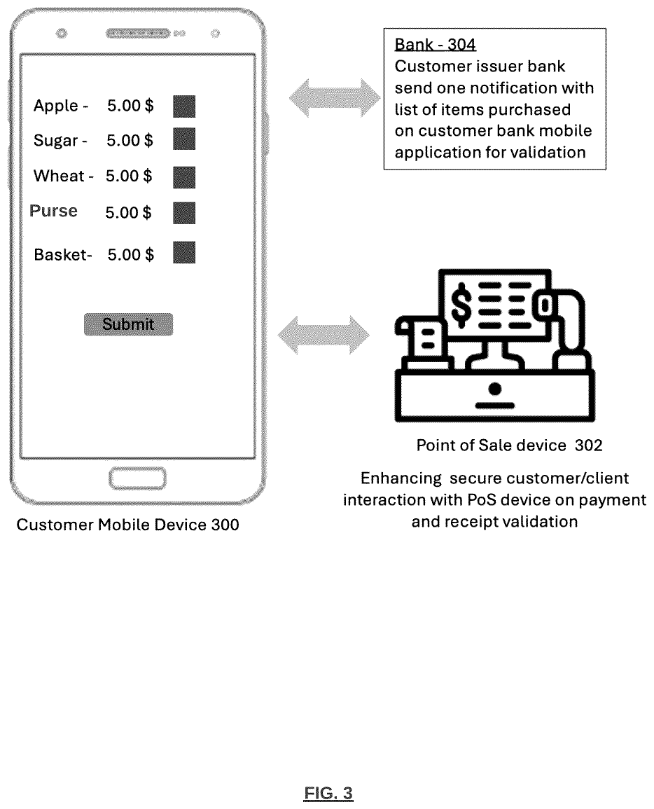

By way of non-limiting disclosure, FIG. 3 intricately illustrates the user interface aspect of the innovative POS transaction system, as displayed on a customer's mobile device during a typical shopping experience. This detailed depiction is essential for understanding how the system enhances the interaction between customers and the POS terminal, ensuring a high level of security and transparency in retail transactions. The diagram showcases a list of grocery items—apples, sugar, wheat, purse, and a basket—each priced at $5.00, that the customer intends to purchase. This list represents a critical feature of the system: real-time communication between the POS terminal and the customer's mobile device. It allows customers to see an itemized list of their purchases before finalizing the transaction, providing an opportunity to review and confirm the accuracy of the items scanned by the merchant.

Below this list is a ‘Submit’ button, a simple yet powerful tool that empowers customers to actively participate in the transaction process. Pressing this button signifies the customer's approval (or rejection) of none, some, or all of the items and prices listed, effectively authorizing the transaction to proceed. This feature addresses common concerns in retail shopping, such as incorrect item scanning or disputes over prices, by involving the customer directly in the verification process.

On the left side of FIG. 3, the ‘Customer Mobile Device’ (300) is highlighted, emphasizing the central role of mobile technology in modern retail transactions. The inclusion of the mobile device in this process is a testament to the system's use of cutting-edge technology to enhance customer experience. It facilitates a seamless, interactive transaction process that goes beyond traditional passive payment methods.

The ‘Bank’ (304) is also depicted, underscoring its role in sending notifications to the customer's mobile device. This notification contains the list of items purchased, mirroring the information provided by the POS device (302). The bank's involvement ensures the integrity of the transaction, acting as a bridge between the merchant's POS system and the customer's personal banking records. This linkage not only enhances the security of the transaction but also provides an added layer of validation, giving customers peace of mind that their financial institution is actively involved in safeguarding their interests.

Furthermore, the ‘Point of Sale device’ (302) is shown as the source of the transaction information, symbolizing its traditional role as the terminal where sales are conducted. However, in the context of this system, the POS device is more than just a point of transaction; it's a point of interaction. By communicating directly with the customer's mobile device, it transforms the transaction process into an interactive experience, fostering a secure and engaging environment for both customers and merchants.

In summary, FIG. 3 provides a detailed visualization of how the POS transaction system leverages mobile technology and real-time data exchange to redefine the shopping experience. By enabling direct customer involvement in the transaction verification process, the system addresses key issues of transparency, accuracy, and security in retail transactions, marking a significant advancement in the field of retail technology.

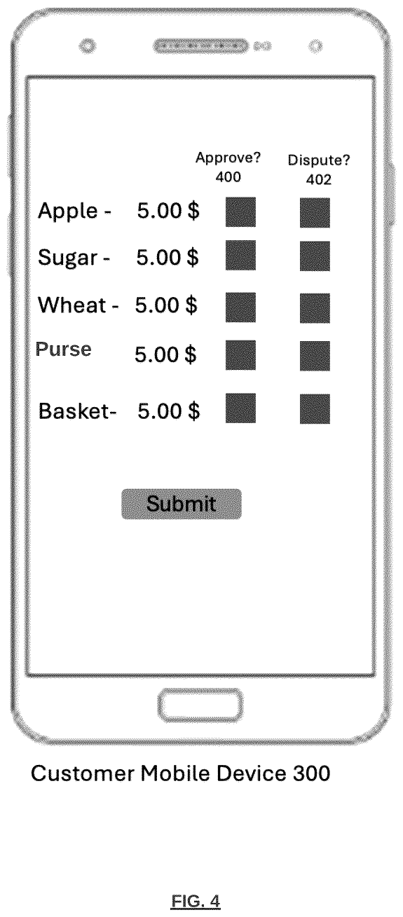

By way of non-limiting disclosure, FIG. 4 in the document provides a focused view on the customer interaction aspect of the POS transaction system, specifically through the customer's mobile device interface during the final stages of validating and completing a transaction. This figure demonstrates the user interface elements and the decision-making process available to the customer regarding their pending purchases.

The interface showcased in FIG. 4 displays a list of items that the customer is about to purchase, similar to the list in FIG. 3 but with added functionality for individual item validation. Each item listed-such as apples, sugar, wheat, pulse, and a basket—has a corresponding price of $5.00, and next to each item are checkboxes or indicators for the customer to either ‘Approve’ (400) or ‘Dispute’ (402) each specific item. This design indicates a move towards an interactive review process, where the customer is given the autonomy to directly confirm or contest the details of each item in their cart before proceeding with the payment.

The inclusion of both ‘Approve’ and ‘Dispute’ options signifies a significant shift towards empowering the customer, ensuring that they have a final say in the accuracy and satisfaction with the transaction. It reflects a system designed with customer trust and engagement at its core, allowing for a more transparent and confident shopping experience. In some embodiments, other GUI or fields may allow the customer to indicate what the particular problem is with the designated item that is being disputed (e.g., wrong price, wrong item, wrong item count, etc.)

Moreover, the ‘Submit’ button at the bottom of the interface is the final step in this interaction, where the customer finalizes their decisions regarding the approval or dispute of items. This action not only confirms the items they wish to purchase but also communicates their decisions back to the POS system for processing. This could lead to adjustments in the final billing based on the disputes raised or proceed with the payment process for approved items.

FIG. 4 encapsulates a key feature of the POS transaction system: enhancing customer control over the transaction process. By integrating direct feedback mechanisms within the transaction flow, the system not only aims to reduce errors and misunderstandings but also builds a foundation of trust and transparency between the customer and the merchant. This detailed interface design illustrates a thoughtful approach to addressing common concerns in retail transactions, offering a blueprint for future enhancements in POS technology.

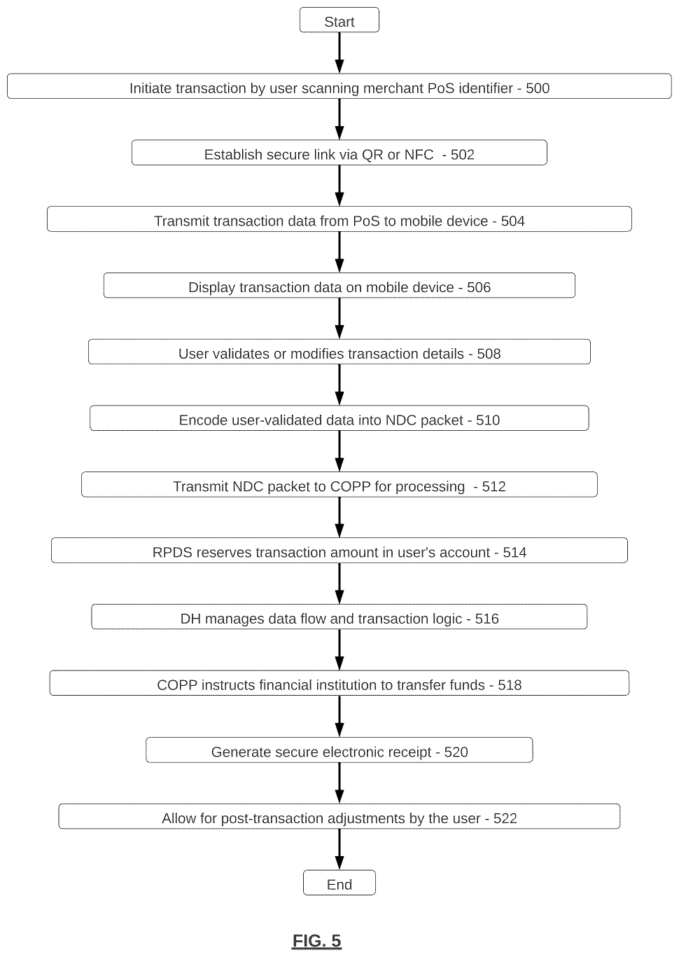

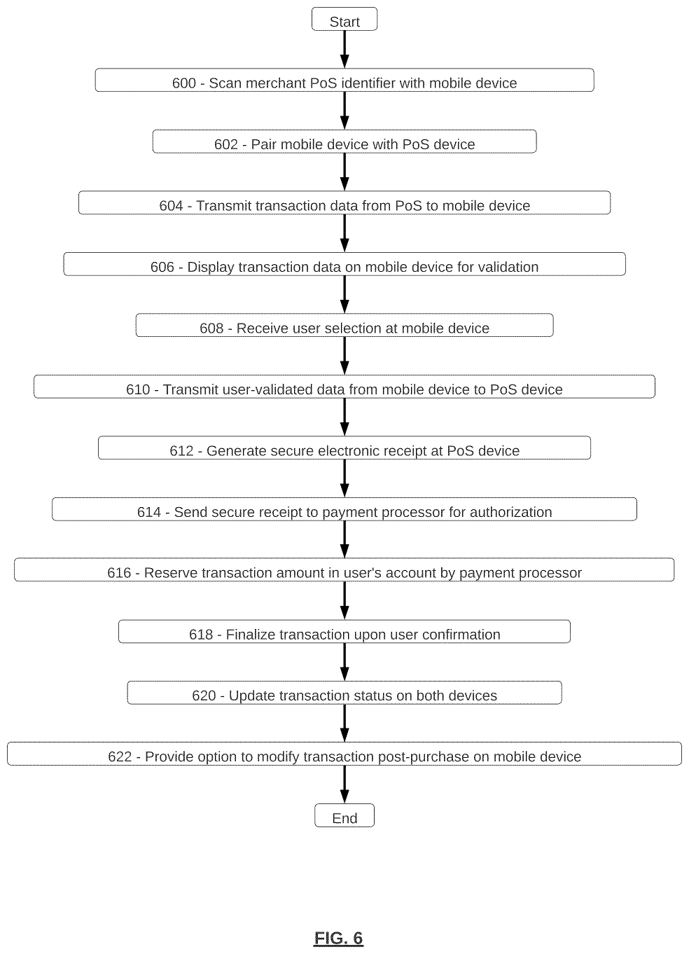

FIGS. 5 and 6 are flow diagrams showing sample interactions, interfaces, steps, functions, and components in accordance with one or more information security aspects of this disclosure.

By way of non-limiting disclosure, FIG. 5 starts by initiation of a transaction by user scanning merchant POS identifier in 500. Next is establishment of secure link via QR or NFC in 502. Transaction data is transmitted from POS to mobile device in 504. Transaction data is displayed on mobile device in 506. User validates or modifies transaction details in 508. User-validated data is encoded into NDC packet in 510. The NDC packet is transmitted to COPP for processing in 512. RPDS reserves transaction amount in user's account in 514.DH manages data flow and transaction logic in 516. COPP instructs financial institution to transfer funds in 518. Generation of a secure electronic receipt occurs in 520. post-transaction adjustments can be made by the user in 522.

By way of non-limiting disclosure, FIG. 6 is a method for securing and validating transactions at a point of sale (POS) device via a mobile device. In 600, initiating a transaction by scanning a merchant POS identifier with a mobile device occurs. Pairing the mobile device with the POS device to establish a communication link is in 602. Transmitting, from the POS device to the mobile device, transaction data including a list of items and respective prices involved in the transaction occurs in 604. Next, displaying the transmitted transaction data on the mobile device for user validation is in 606. Receiving at the mobile device, a user selection including validation or modification of the transaction data is in 608. In 610, transmitting the user-validated transaction data from the mobile device back to the POS device is performed. In 612, generating, by the POS device, a secure electronic receipt based on the user-validated transaction data is performed. Sending the secure electronic receipt to a payment processor for transaction authorization is in 614. In 616, reserving, by the payment processor, an amount corresponding to the transaction in the user's account is performed. Upon user confirmation, finalizing the transaction by deducting the reserved amount from the user's account is in 618. Updating the transaction status on both the POS device and the mobile device is in 620. Last, in 622, an option on the mobile device is provided to modify the transaction post-purchase for returns or disputes, wherein the modification triggers an update to the transaction and adjusts the user's account accordingly.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for secure transaction processing at a point of sale (POS) device using a mobile device, the method comprising:
initiating a transaction by a user scanning a merchant POS identifier using the mobile device;
establishing a secure communication link between the mobile device and the POS device through the scanning of a QR code or through NFC (Near Field Communication);
transmitting transaction data from the POS device to the mobile device, the transaction data including a detailed list of items with respective prices involved in the transaction;
displaying the transaction data on the mobile device, allowing the user to validate or modify the list of items, thereby enabling the user to confirm transaction details accurately;
upon user validation, encoding the user-validated transaction data into a New Distribution Capability (NDC) packet, optimized for secure data exchange across distributed systems;
transmitting the NDC packet to a Control Object Payment Processor (COPP) to process the transaction, wherein the COPP is configured to interface with both the mobile and POS devices, facilitating authentication of the transaction data and ensuring compliance with financial transaction standards;
utilizing a Reserved Payment Drive Switch (RPDS), by the COPP, reserves the transaction amount in the user's account without finalizing the transaction, thereby securing funds for the transaction while allowing for any subsequent adjustments prior to final transaction completion;
operating, a Device Handler (DH), within the transaction processing system, dynamically managing the data flow and transaction logic between the POS device, mobile device, COPP, and financial institutions, ensuring that the transaction adheres to predefined security and processing rules;
finalizing the transaction by the COPP sending an instruction to the financial institution to transfer the reserved amount from the user's account to the merchant's account, upon receiving final confirmation from the user via the mobile device;
generating a secure electronic receipt that is transmitted to both the user's mobile device and the POS device, providing a record of the transaction for both parties; and
allowing for post-transaction adjustments by the user through the mobile device, wherein the user can initiate returns or disputes, with the system dynamically updating the transaction records and adjusting the financial accounts as necessary, facilitated by the RPDS, COPP, and DH components ensuring seamless and secure transaction modification and settlement.

2. The method of claim 1, further comprising utilizing a biometric authentication step on the mobile device, wherein the user must authenticate their identity via fingerprint, facial recognition, or voice verification before the transaction data is transmitted to the COPP for processing, enhancing the security of a transaction initiation phase.

3. The method of claim 2, wherein the secure communication link established between the mobile device and the POS device is encrypted using an advanced encryption standard (AES) with a key length of at least 256 bits, ensuring that the transaction data transmitted is protected against interception and unauthorized access.

4. The method of claim 3, further including a step of the COPP dynamically selecting a transaction processing route based on a type of transaction, the transaction amount, and a current network load, wherein the RPDS assists in dynamically allocating resources for the transaction processing, thereby optimizing the transaction processing time and efficiency.

5. The method of claim 4, wherein upon user validation of the transaction on the mobile device, the COPP generates a unique transaction identifier (UTI) that is embedded within the NDC packet, with the UTI being used by the DH to track and manage the transaction through various stages of processing, providing for audit trails and transaction verification.

6. The method of claim 5, further comprising a step of the system sending a notification to both the user's mobile device and the merchant's POS device upon successful transaction completion, wherein the notification includes the UTI and a summary of the transaction details, and wherein the system also updates transaction status in real-time on a user-accessible platform, enhancing transparency and providing immediate confirmation of transaction status to both the user and the merchant.

7. A method for securing and validating transactions at a point of sale (POS) device via a mobile device, comprising:
initiating a transaction by scanning a merchant POS identifier with a mobile device;
pairing the mobile device with the POS device to establish a communication link;
transmitting, from the POS device to the mobile device, transaction data including a list of items and respective prices involved in the transaction;
displaying the transmitted transaction data on the mobile device for user validation;
receiving, at the mobile device, a user selection including validation or modification of the transaction data;
transmitting the user-validated transaction data from the mobile device back to the POS device;
generating, by the POS device, a secure electronic receipt based on the user-validated transaction data;
sending the secure electronic receipt to a payment processor for transaction authorization;
reserving, by the payment processor, an amount corresponding to the transaction in the user's account;
upon user confirmation, finalizing the transaction by deducting the reserved amount from the user's account;
updating the transaction status on both the POS device and the mobile device; and
providing an option on the mobile device to modify the transaction post-purchase for returns or disputes, wherein the modification triggers an update to the transaction and adjusts the user's account accordingly.

8. The method of claim 7, further comprising scanning a QR code displayed on the POS device with the mobile device to initiate the transaction and establish the communication link.

9. The method of claim 8, wherein the communication link between the mobile device and the POS device is established using a secure wireless protocol selected from the group consisting of Bluetooth, Wi-Fi, and NFC (Near Field Communication).

10. The method of claim 9, further comprising encrypting the transaction data transmitted between the POS device and the mobile device using an end-to-end encryption protocol.

11. The method of claim 10, wherein the user selection includes deselecting one or more items from the list of items displayed on the mobile device, thereby modifying a total transaction amount.

12. The method of claim 11, further comprising applying a user-specific discount or loyalty points to the transaction based on the user-validated transaction data before finalizing the transaction.

13. The method of claim 12, wherein the secure electronic receipt includes a digital signature of the merchant and a transaction timestamp.

14. The method of claim 13, further comprising storing the secure electronic receipt in a digital wallet application on the mobile device.

15. The method of claim 14, wherein the option to modify the transaction post-purchase includes initiating a return process directly from the mobile device by deselecting a returned items on the digital receipt within the digital wallet application.

16. The method of claim 15, further comprising notifying the POS device of the initiated return process to update a merchant inventory system accordingly.

17. The method of claim 16, further comprising generating a new secure electronic receipt reflecting a modified transaction post-return, including an updated total transaction amount and an indication of the returned items.

18. A system for secure transaction processing at a point of sale (POS) comprising:
a mobile device equipped with software for initiating transactions by scanning a merchant's POS identifier, capable of displaying transaction data for user validation and modifications, and transmitting user-validated transaction data;
a POS device configured to generate transaction data upon scanning of items, display a QR code or enable NFC for mobile device pairing, and receive user-validated transaction data from the mobile device;
a New Distribution Capability (NDC) module responsible for encoding transaction data into an NDC packet for secure and optimized data exchange across distributed systems;
a Control Object Payment Processor (COPP) interfaced with both the mobile device and the POS device for processing NDC-encoded transaction data, authenticating the transaction, and communicating with financial institutions for transaction authorization;
a Reserved Payment Drive Switch (RPDS) integrated with the COPP to reserve the transaction amount in the user's account without finalizing the transaction, allowing for subsequent adjustments before completion;
a Device Handler (DH) to manage flow of transaction data and logic between the mobile device, POS device, COPP, RPDS, and financial institutions, ensuring compliance with security and processing rules;
a secure communication link established between the mobile device and the POS device using encryption protocols to protect the transaction data from unauthorized access;
a transaction completion module within the COPP to instruct financial institutions to transfer the reserved amount from the user's account to the merchant's account upon final confirmation; and
a secure electronic receipt generator for creating and transmitting electronic receipts to both the user's mobile device and the POS device, recording the completed transaction.

19. The system of claim 18, wherein the mobile device further comprises a biometric authentication module enabling user identity verification through fingerprint scanning, facial recognition, or voice verification before transaction initiation, enhancing the security of the transaction process by ensuring that the transaction is initiated by the authorized user.

20. The system of claim 19, further comprising:
a dynamic routing module within the COPP, capable of selecting the most efficient transaction processing route based on transaction type, amount, and current network conditions, utilizing the RPDS for dynamic resource allocation to optimize processing efficiency and reduce transaction time;
an encryption module utilizing advanced encryption standards (AES) with a key length of at least 256 bits to encrypt the secure communication link between the mobile device and the POS device, ensuring confidentiality and integrity of the transaction data during transmission; and
a unique transaction identifier (UTI) generation module within the COPP, assigning a UTI to each transaction for tracking and management by the DH, facilitating audit trails, transaction verification, and enhancing system reliability through precise tracking of each transaction's lifecycle.
